(19) United States
(12) Patent Application Publication
(10) Pub. No.: US 2009/0056141 A1
(43) Pub. Date: Mar. 5, 2009

(54) SHAVING IMPLEMENT AND METHOD FOR USING SAME

(75) Inventors: Kevin S. Barry, Fairfield, CT (US); Dave Ross, Orange, CT (US)

Correspondence Address: Michaud-Duffy Group LLP, 306 Industrial Park Road, Suite 206, Middletown, CT, 06457, US

(73) Assignee: EVEREADY BATTERY COMPANY, INC., St. Louis, MO (US)

(21) Appl. No.: 11/956,645

(22) Filed: Dec. 14, 2007

Related U.S. Application Data
(63) Continuation-in-part of application No. 11/897,060, filed on Aug. 28, 2007.

(51) Int. Cl. B26B 21/40

(52) U.S. Cl. 30/41.7; 30/541

(57) ABSTRACT

According to one aspect of the present invention, a wet shaving system includes two integrated components, namely a shaving device (e.g., a wet shave razor) and a base. The shaving device includes a handle and razor cartridge. During use, the shaving device is separated from the base and used by a user to shave. Between uses, the shaving device is stored on the base. The base is operable to detect when a user has removed the handle for the purpose of shaving, count the number of shaves the razor cartridge has been used by the user, and notify the user once a given number of shaves have been completed in order to, for example, prompt the user to consider replacing the replaceable shaving cartridge on the current handle or to begin using a new razor and handle.

### CROSS REFERENCE TO RELATED APPLICATION

The present application is a Continuation-in-Part (CIP) of U.S. patent application Ser. No. 11/897,060, filed on Aug. 28, 2007.

### FIELD OF THE INVENTION

This invention relates generally to shaving implements and, more particularly, to a wet shaving system in which usage of a razor cartridge is monitored and information concerning such usage is conveyed to a user.

### BACKGROUND OF THE INVENTION

Modern wet shave razors generally employ a disposable razor cartridge. As the blades housed within the razor cartridge becomes dull from repeated use, the quality of subsequent shaving experiences deteriorates. Eventually, shave quality deteriorates to a point where the cartridge must be replaced. A difficulty occurs in that users often do not monitor or remember how many times a particular razor cartridge has been used. As such when it is time to change a cartridge the user may not have one on hand, thereby forcing the user to potentially endure an uncomfortable shave until such time as a replacement razor cartridge can be obtained.

Hair differs with regard to hardness, with harder hair being more difficult to cut. The hardness of hair is determined by the amount of keratin in the hair. Keratin is a natural fibrous protein that is made up of several different amino acids. The proportions of these amino acids that make up the keratin vary between people, thereby resulting in differences in hair hardness. These differences in hair hardness, as well as differences in personal shaving technique, in turn, results in differing wear rates for wet shave razor cartridges. Accordingly, depending on the characteristics of a user's hair, the useful life expectancy of a razor cartridge will vary from user to user. Since razor cartridges also differ (i.e., some are higher quality than others, and some have more blades than others) it is sometimes difficult for a user to determine and/or predict how many shaves can be comfortably obtained from a particular type of razor cartridge. This problem is further exacerbated by the fact that different users shave differently. Some may use more strokes than others, and some may use longer or shorter strokes than others. These factors each affect the useful life of a razor cartridge. Accordingly, there is a current need for a way by which a user can determine and monitor the useful life of a razor cartridge.

Based on the foregoing, it is a general object of the present invention to provide a shaving device that provides a user with feedback regarding the quality of a razor cartridge over time.

### SUMMARY OF THE INVENTION

According to one aspect of the present invention, a wet shaving system includes two integrated components, namely a shaving device (e.g., a wet shave razor) and a base. The shaving device includes a handle and razor cartridge. During use, the shaving device is separated from the base and used by a user to shave. Between uses, the shaving device is stored on the base. The base is operable to detect when a user has removed the handle for the purpose of shaving, count the number of shaves the razor cartridge has been used by the user, and notify the user once a given number of shaves have been completed in order to, for example, prompt the user to consider replacing the replaceable shaving cartridge on the current handle or to begin using a new razor and handle.

According to another aspect of the present invention, the handle and base can communicate via an inductive link to transmit information.

According to a further aspect of the present invention, the handle can be free of electronics. In these embodiments, the base includes electronics that can qualify a shave with any off-the-shelf razor, including both disposable and system razors.

According to an even further aspect of the present invention, the base can include a memory device that can, over time, average the number of shaves performed per razor cartridge and display that information to the user.

One advantage of the present invention is that the user can receive information from the base in order to assist in making a judgment whether or not to begin using a new razor cartridge.

This and other advantages will become evident in light of the Detailed Description and included Drawings herein.

### BRIEF DESCRIPTION OF THE DRAWINGS

FIG. 1 is a perspective view of the wet shaving system of the present invention having a shaving device and an integrated base;

FIG. 2 is a side cutaway view of a razor head of the shaving device of the present invention;

FIG. 3 is a perspective view of a razor head of the shaving device of the present invention;

FIG. 4 is a side cutaway view of a shaving device of the present invention;

FIG. 5 is a perspective view of one embodiment of the base of the present invention;

FIG. 6 is a perspective view of one embodiment of the base of the present invention;

FIG. 7 is a perspective view of one embodiment of the base of the present invention;

FIG. 8 is a schematic representation of an electronic control module in the shaving unit;

FIG. 9 is a side cutaway view of the base of the present invention;

FIG. 10 is a schematic representation of display in the shaving unit;

FIG. 11 is a side cutaway view of the shaving device inserted in the base;

FIG. 12 is a side cutaway view of the base of the present invention; and

FIG. 13 is a side cutaway view of the shaving device inserted in the base.

### DETAILED DESCRIPTION OF THE PREFERRED EMBODIMENTS

Disclosed herein are wet shaving systems and methods of their use. As used herein, wet shaving systems are those in which a shaving device is used in conjunction with water and/or a shaving aid, typically in a bathroom environment where water is readily available, in order to facilitate the removal of hair from the user's body. Typically, the shaving devices employ flexible razor blades having sharpened edges. However, the present invention should not be considered limited to such razor blades.

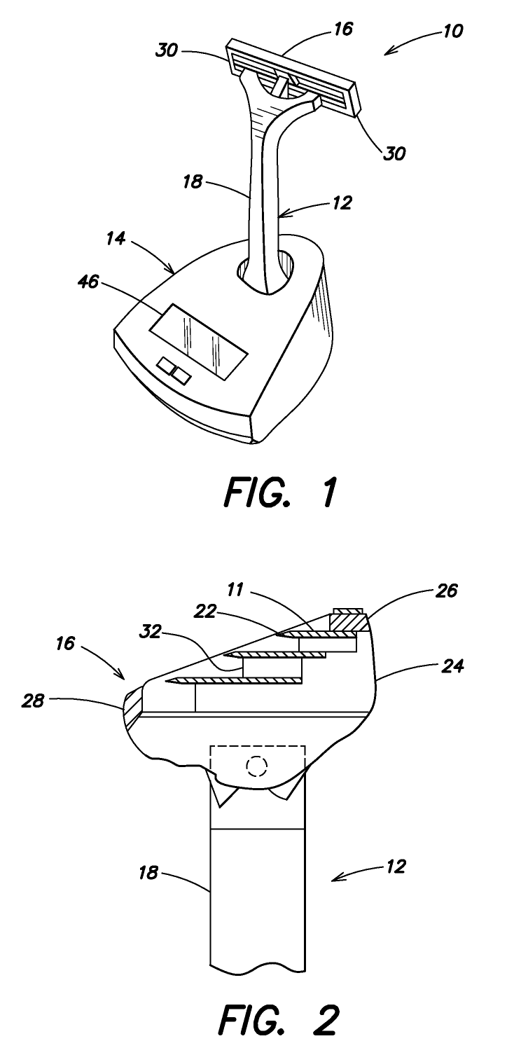

Referring to FIG. 1, a wet shaving system of the present invention is shown generally at 10 and hereinafter referred to as “system 10.” The system 10 is defined by two integrated components, namely a shaving device 12 (e.g., a wet shave razor) and a base 14. During use, the shaving device 12 is separated from the base 14 and held by the user. Between uses, the shaving device 12 is stored on the base 14. The base 14 is operable to detect when a user has removed the shaving device 12 for the purpose of shaving, count the number of shaves the razor cartridge has been used by the user, and notify the user once a given number of shaves have been completed.

Referring to FIG. 2, the shaving device 12 comprises a razor cartridge 16 mounted on a handle 18. The razor cartridge 16 can be mounted such that it is replaceable on the same handle 18 (i.e., “system razors”), or, alternatively, the razor cartridge 16 can be mounted such that is not intended to be removed during normal use (i.e., “disposable razors). In the latter, the disposable razor is intended to be discarded, as a whole, and a new handle 18 and razor cartridge 16 put into use in its place. In the former, the razor cartridge 16, once spent, is replaced by a replacement razor cartridge 16 on the same handle 18, and only the spent razor cartridge 16 is discarded. In addition, the razor cartridge 16 can be pivotally mounted to the handle 18.

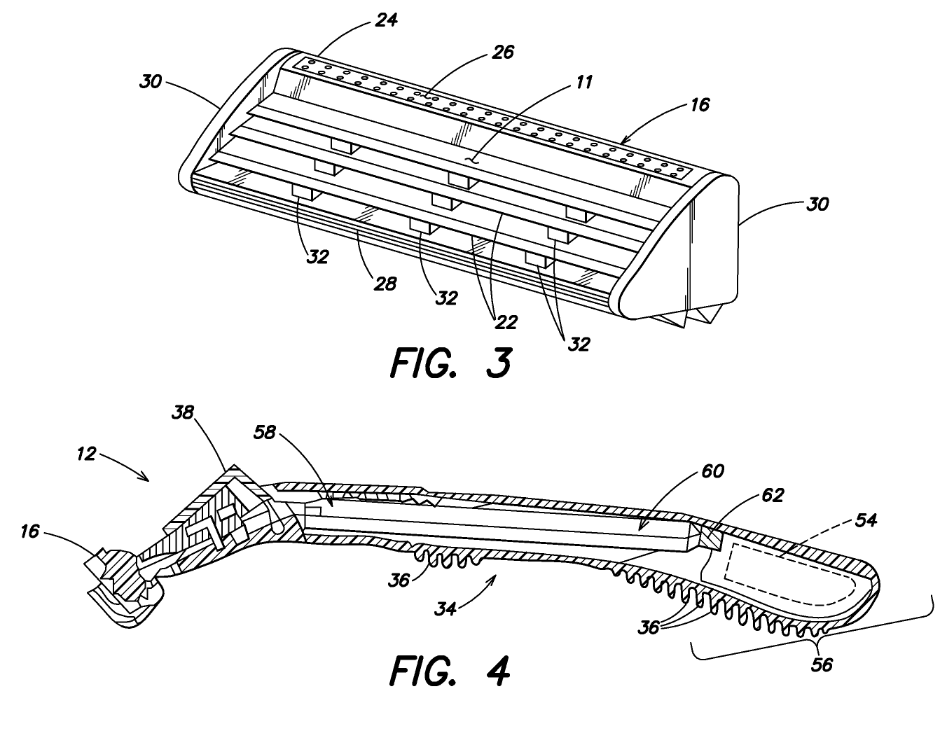

The razor cartridge includes a number of blades 11. As shown in FIG. 3, the razor cartridge 16 includes three (3) blades 11; however, the razor cartridge can include more than three (3) blades 11 (e.g., four (4), five (5), six (6), or more), or as few as one (1) without departing from the scope of the present invention. The blades 11 shown in FIG. 3 are shown as having a linear cutting edge 22; however, the present invention is not so limited since the cutting edge 22 of the razor blades can be, for example, curved. Preferably, the razor blades 11 are mounted within a frame 24 or similar structure having a cap 26, a guard 28, and end walls 30. The cap 26 may further include a comfort strip having some type of shaving aid included therein. In some embodiments, spacers 32 can be positioned between the blades to maintain proper spacing between the razor blades 11 and to provide support to the otherwise flexible blades 11. However, the present invention should not be considered so limited. Alternatively, for example, it is well known to affix the razor blades 11 to a bent blade support (not shown) and position in a frame such that the razor blades 11 are not fixedly mounted.

Referring now to FIG. 4, the handle 18 of the shaving device comprises an elongated grip portion 34 that can be ergonomically shaped in order to be easily gripped by the user during use. Outer surfaces of the handle may be at least partially covered with an elastomeric (or other high friction material) to allow the user to positively grip the handle 18. In addition, the handle 18 can include ridges or bumps 36 to further increase ease of use.

In some embodiments, where the razor cartridge is replaceable on the same handle 18, a release switch assembly 38 is mounted on the handle 18 and provides the user with the ability to release the razor cartridge 16 from the handle 18.

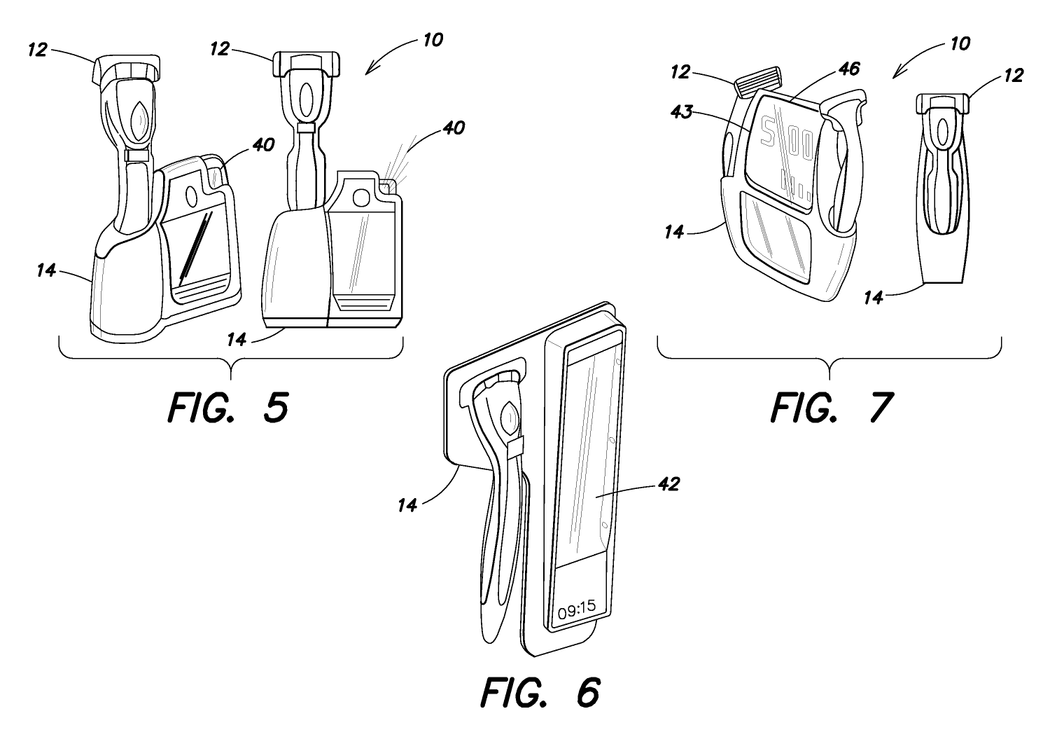

Referring now to FIGS. 5-7, the base 14 can, without departing from the present invention, have a number of different configurations and features. For example, as shown in FIG. 5, the base can include a nightlight 40 that is, optionally, used in conjunction with a light and/or motion sensor(s) (not shown) in order to activate, for example, only when it is dark out and/or someone is moving within a given distance of the base. As shown in FIG. 6, the base can include a mirror 42. In these embodiments, it is often preferable to seal the mirror 42 in order to ensure it is operable in a wet and steamy environment. FIG. 7 depicts a base that can hold more than one shaving device 12. It should also be noted that, although FIGS. 1 and 5-7 show bases 14 that hold the shaving device 12 in a generally vertical manner, the present invention is not to be considered so limited. For example, it is also known for a base 14 to hold a shaving device 12 in a generally horizontal manner. In each case however, the base 14 wraps around at least a portion of the handle 18.

Each of the bases 14 of the present invention utilizes some form of electronics (described in further detail infra.). Therefore, each base 14 must be powered in some manner. Any known form of powering electronic devices, such as, but not limited to, AC power, battery, solar power, or any combination thereof is acceptable.

In addition, in order to effectively communicate to the user, the base 14 typically further includes one or more displays 46, as shown in FIGS. 1 and 5-7. The information conveyed via the displays 46 will be discussed in greater detail infra.; however, the display(s) can be further utilized to convey any of the following non-limiting pieces information: time (e.g., via an atomic clock), local traffic and weather or music (e.g., via an AM/FM signal), date (e.g., via a programmable calendar), and/or selectively programmable alarm 43. LED displays, LCD displays and audio speakers are the most common displays 46 that can be utilized in the present invention.

As discussed below, the base 14 and shaving device 12 function together to automatically count the number of shaves a single razor cartridge 16 has undergone, and to convey that number to the user. Optionally, the base 14 can include means for enabling the user to manually adjust the number of shaves shown on the base 14 display 46. For example, should a shave that actually took place fail to be qualified for any reason, or if a shave is qualified when one should not have been, buttons 48, for example, can be provided so that the user can manually add or subtract “a shave” from the running tally when errors occur.

As noted above, the base 14 is capable of counting the number of shaves for which the razor cartridge has been used. A number of embodiments are provided below for automatically counting, or “qualifying”, shaves.

Inductive Link Base

Referring now to, for example, FIGS. 4, 8 and 9, in the present embodiment, both the handle 18 and the base 14 include communication devices 50. In the presently described embodiment, the base 14 and handle 18 cooperate to determine when a shave has occurred, as well as when the razor cartridge 16 has been replaced. For the purpose of detecting when the razor cartridge 16 has been replaced, the handle 18 includes a release switch assembly 38 and an electronic control module 54. The release switch assembly 38 is mounted within the handle 18 and provides operable communication between the razor cartridge 16 and the electronic control module 54 in a rearward position 56 of the handle 18. A forward portion 58 of the release switch assembly 38 is releasably attached to the razor cartridge 16, and a rearward portion 60 of the release switch assembly 38 is attached to a magnet 62.

Referring now to FIG. 5, the electronic control module 38 comprises at least one sensor 64 capable of detecting movement of the handle 18 (e.g., tilt sensor 70 or a miniaturized accelerometer (not shown)). In the embodiment shown, the electronic control module 38 includes a microcontroller 66, a magnetic reed switch 68, a tilt sensor 70, and a coil assembly 71. The microcontroller 66 is a printed circuit board (PCB) 72 that is in communication with the magnetic reed switch 68, the tilt sensor 70, and the coil assembly 71. Preferably, the microcontroller 66 includes a memory device 74 for storing data related to the movement of the handle 18 as well as a capacitance device that stores and provides power to the components of the PCB 72. A battery (not shown) can also be used in lieu of the capacitance device to store and provide power. The entire electronic control module 38 is preferably potted in a waterproof compound and self-contained, thus eliminating the opportunity for liquid water or condensate to collect and adversely affect the circuitry on the microcontroller 66. Because the shaving device 12 operates via inductive coupling, there are no wires or other physical links that extend from the electronic control module.

The reed switch 68 comprises two reeds, at least one of which is magnetic, that are independently mounted and biased so as to be out of contact with each other when not in the presence of the magnetic field of the magnet 62 of the release switch assembly 38. The tilt sensor 70 is a level sensing device and may be a bubble in an encapsulated liquid, a flapper that is pivotably mounted and weighted to rotate so that one portion thereof is always in a particular orientation, or the like. In any embodiment of the tilt sensor 70, the sensor reads the position and conveys a signal to the microcontroller 66 for processing (e.g. the number of changes from an upward vertical orientation to a level or downward vertical orientation (“tilts”)). The coil assembly 71 is a wrapping of wires 78 that, when the shaving device 12 is inserted in the base 14, is in magnetic communication with a power transformer 80 in the base 14 to provide power to the microcontroller 66.

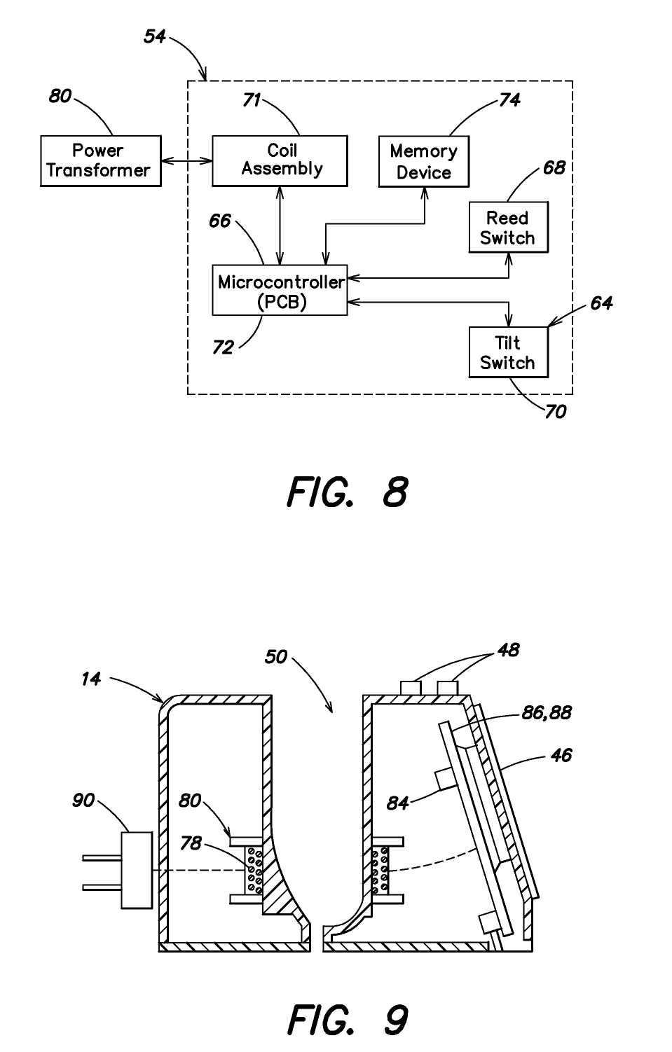

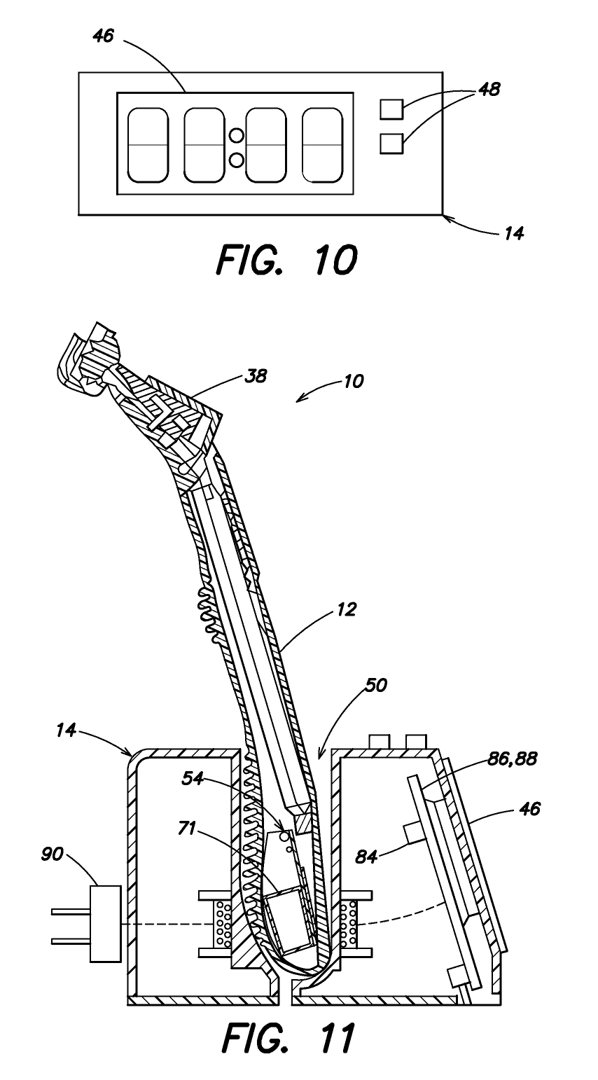

The base, shown in FIG. 9, includes a base microcontroller 86 in the form a PCB 88 that is disposed in electronic communication with the power transformer 80 and the display 46. A software algorithm in the PCB 88 provides a means for transferring data from the memory device 74 of the microcontroller 66 in the handle 18 to the base microcontroller 86.

When the shaving device 12 is returned to the base 14 after use, data is transferred via the inductive link to the base microcontroller 84. Two types of data can be transferred. First, as determined by the software algorithm, the handle 18 will transmit whether a shave has occurred. A shave can be qualified in a number of different manners using the tilt, or similar, sensors 70, that can detect a minimum amount of handle 18 motion (e.g., five (5) tilts of the handle 18) to indicate that a shave has most likely taken place. The qualification is preferably based on experimental data that mimics the tendencies of an average shaver. Based on the qualification test in the software algorithm and the actual motion detected by the sensor(s) 70, a shave is qualified. The data, namely, an indicator of whether a shave has occurred is then transferred when the handle is in magnetic communication with the base 14. Second, the handle 18 can transfer data relevant to whether the razor cartridge 16 has been replaced on the handle 18, as detected by the reed switch 68. Referring now to FIG. 8, when the shaving device 12 is inserted into the base and when the AC line is connected to an AC power source 90, the coil assembly 71 is positioned proximate the power transformer 80 in the base 14. Magnetic communication between the coil assembly 71 and the power transformer 80 provide for the charging of the capacitance device of the microcontroller 66 of the electronics control module 38 in the handle 38. Because of the use of inductive coupling, the system is a low current device and can typically provide two shaves over a period of about twenty-six hours without the shaving device 12 being returned to the base 14.

As is shown in FIGS. 8 and 9, as discussed above, the base 14 comprises a display 46. When the shaving device 12 is removed from the base 14 for a shaving operation, the indicator of the number of shaves at the culmination of the previous shaving operation is briefly displayed. When the shaving device 12 is returned to the base after a shaving operation, an indication of the number of shaves is briefly displayed. In the event that a shave has been qualified, depending on the manner in which the base is counting shaves, the total number of shaves displaced is increased or decreased by one (1).

In addition, the base 14 may include a memory device 86. The memory device 86 stores the number of total shaves used by each razor cartridge 16 before being replaced. By averaging (or similar manipulation of the data) the total number of shaves for a number of razor cartridges 16, the base 14 can begin to accurately predict, over time, the number of shaves the user can expect a razor cartridge 16 to last before needing to replace it. For example, if the base 14 counts down from a total number of shaves, then the base can begin counting down from the expected total (e.g., based on an average total number of shaves for a number of cartridges) each time a new razor cartridge 16 is attached to the handle 18. In this manner, the wet shaving system 10 “personalizes” itself to the user's individual habits. Alternatively, in a base 14 where the display counts upwards, the base 14 can indicate to the user (e.g., by blinking the total number of shaves on the display 46) that the user is approaching the end of the life of the razor cartridge 16.

Non-Inductive Link Base

Alternatively, the wet shaving system 10 can be designed to be used with any “off the shelf” shaving device 12. In other words, in these embodiments, the shaving device 12 cannot be altered to include electronics therein. Therefore, the electronics, in these embodiments, are all located within the base 14.

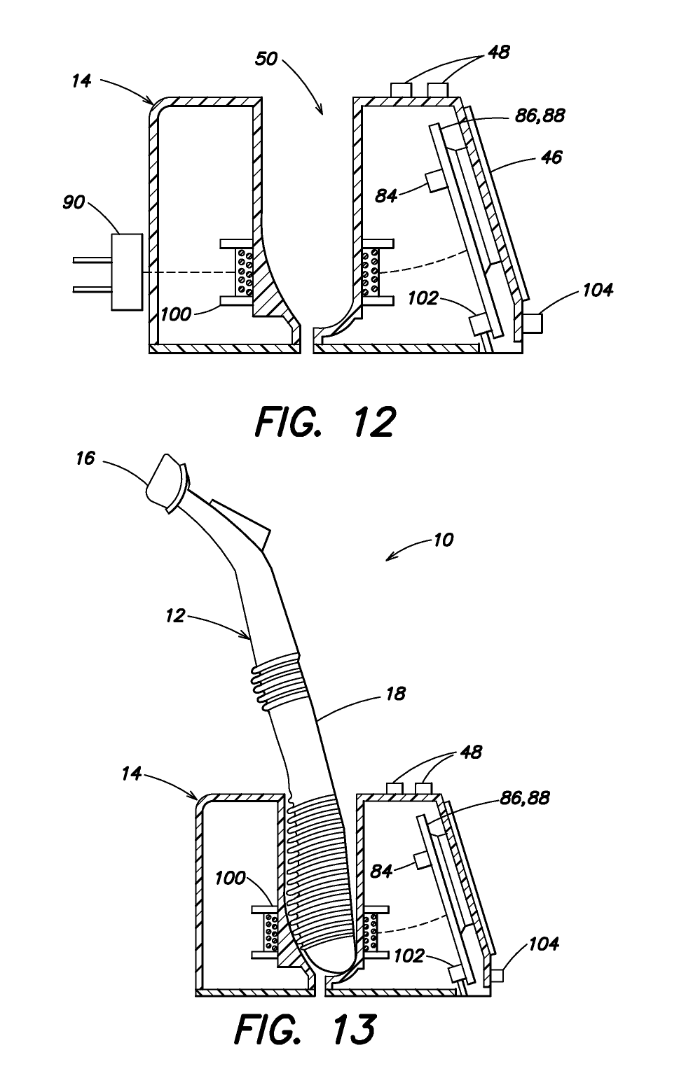

Referring now to FIGS. 12 and 13, the base includes a proximity sensor 100, a timer 102, a PCB 72, and a display 46. The proximity sensor 100 is positioned in the base such that it is able to determine when the shaving device 12 is on the base and when it has been removed. When the shaving device 12 is not on the base, the timer 102, also located in the base 14, is triggered. Once the shaving device 12 has been removed from the base 14 for a pre-set amount of time (e.g., 5-30 seconds), the PCB qualifies the removal of the shaving device 12 as having undergone a shave. Accordingly, the total number of shaves is changed by one (1) on the display 46, either immediately or once the shaving device 12 is returned to the base 14 and is re-detected by the proximity sensor 100.

Optionally, once the handle 18 is replaced on the base 14, the timer 102 starts again and another shave cannot be qualified for a period of time. Essentially, the timer 102 enables the system to prevent incorrectly qualifying a shave that most likely did not occur. For example, if the shaving device 12 is jostled when being placed on, or removed from, the base 14, the proximity sensor 100 may detect the shaving device 12 several distinct times, often only fractions of a second apart. Since it is highly unlikely, that more than one shave took place during that amount of time, the PCB 72 does not permit itself to detect more than one shave during a pre-set period of time with the aid of the timer 102.

In addition, the base 14 must also include a reset button 104 that the user depresses manually when a new razor cartridge is put into use (e.g., when a new replaceable razor cartridge is attached to the handle, or when a new handle and razor cartridge are put into use). Once depressed, the display 46 is reset. In some embodiments, the total number can be reset to zero (0) (e.g., in systems where the shaves are counted incrementally upwards), or to an estimated total number of shaves expected from the next razor cartridge (e.g., 20) for systems where each shave reduces the total by one.

Optionally, the base can further include a memory device 86. Once the total number of shaves for a razor cartridge 16 is known (e.g., when the user depresses the reset button), that total number is stored in the memory device 86. Once the total number of shaves for more than one razor cartridge 16 is known, the PCB can adapt to provide a user-specific estimated total. For example, if the first razor cartridge used in conjunction with the base is used for 20 shaves, the system can pre-set the expected number of shaves for the next razor cartridge at 20. If the second razor cartridge 16 is used for 18 shaves, the memory device and PCB can combine the data from all the previous razor cartridges and provide, as a new estimate for total shaves, an aggregate average. Over time, as more and more razor cartridges 16 are used by an individual, the more accurate the base will be able to predict how many shaves the user can expect for which to use a single razor cartridge 16.

Upon reaching the estimated number of shaves, the base 14 can notify, or simply warn, the user that the time to switch razor cartridges 16 is approaching. In the embodiment where the base 14 counts down from an estimated total number of shaves, the display 46 inherently conveys the time to consider changing the razor cartridge as the total number of shaves remaining on the display approaches zero (0). However, in other embodiments (e.g., where the display counts incrementally upwards), or in combination with the display that counts down, additional warning signals (e.g., visual 106 and/or audio 108) can be provided as an additional reminder to the user.

Any appropriate proximity sensor 100 can be used; however, beam sensors are considered especially useful. For example, an Infrared light sensor, an acoustic sensor (e.g., through the use of a “ping” and echo return), a capacitive sensor, and a pressure sensor are all commercially available and can all be used to determine whether the shaving device is located in the base, or not.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention not be limited to the particular embodiments disclosed in the above detailed description, but that the invention will include all embodiments falling within the scope of the appended claims.

What is claimed is:

1. A wet shaving system, comprising:
a shaving device including,
a handle,
at least one razor cartridge coupled to the handle,
an electronic control module integrated into the handle and including a sensor for detecting movement of the handle, and
memory means for storing data related to the movement; and
a base adapted to removably receive at least a portion of the wet shave razor, the base unit including,
a display for indicating the number of shaves the razor cartridge has undergone to the user,
a controller in communication with the display for sending data thereto pertaining to razor cartridge use, and
transfer means for transferring data from said memory means to said controller when at least a portion of said wet shave razor is received by the base;
wherein the electronic control module is capable of qualifying a shave once a pre-determined set of criteria has been accomplished; and
wherein the memory means transfers information pertaining to.

2. A wet shaving system, comprising:
a shaving device including,
a handle,
at least one razor cartridge coupled to the handle; and
a base adapted to removably receive at least a portion of the wet shave razor, the base unit including,
a display for indicating the number of shaves the razor cartridge has undergone to the user,
a proximity sensor for determining whether the wet shave razor is located in the base; and
a timer;
wherein the timer is triggered once the shaving device is removed from the base, and
wherein the shave is qualified once the shaving device has been removed for a pre-set period of time.
